(19) United States
(12) Patent Application Publication
(10) Pub. No.: US 2005/0256294 A1
(43) Pub. Date: Nov. 17, 2005

(54) Golf balls formed using compositions containing copolymers derived from polytrimethylene ether glycol

(76) Inventors: Hari Babu Sunkara, Hockessin, DE (US); John Chu Chen, Hockessin, DE (US); Joseph V. Kurian, Hockessin, DE (US); Peter A. Morken, Wilmington, DE (US); Ray W. Miller, Kennett Square, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/128,978

(22) Filed: May 13, 2005

Related U.S. Application Data
(60) Provisional application No. 60/571,557, filed on May 14, 2004.

(51) Int. Cl. C08G 63/78

(52) U.S. Cl. 528/279

(57) ABSTRACT

A golf ball having a polytrimethylene ether glycol-based polymer in one or more layers of the ball is disclosed. The polytrimethylene ether glycol polymer is disclosed as being derived from polyether ester elastomers comprising a polytrimethylene ether soft segment; polyether-ester-amide elastomers comprising a polytrimethylene ether soft segment; and polyurethanes and polyurethane-ureas prepared by reaction of (a) polytrimethylene ether glycol, (b) diisocyanate, and (c) diol or diamine chain extender.

This application claims the benefits of U.S. Provisional Application 60/571,557, filed May 14, 2004, the entire disclosure of which is incorporated herein by reference.

### FIELD OF THE INVENTION

This invention relates to golf balls, and in particular, golf balls having multiple layers, wherein at least one of the layers comprises a copolymer comprising polytrimethylene ether segment or a blend of polytrimethylene ether glycol based copolymer with other polymers.

### BACKGROUND OF THE INVENTION

1,3-Propanediol (“PDO”) is a versatile building block for making polymers. For example, poly(trimethylene terephthalate), or “PTT” is well known and commercially available as polymer or fiber, suitable for many end uses. Other polymers derived from PDO include polyethers and polyether based copolymers. Among these are polytrimethylene ether glycol (“PO3G”) and its block copolymer derivatives. PO3G is the low molecular weight polyether polyol produced from polycondensation of PDO and has been described in a number of patents and patent applications. PO3G has numerous uses, especially in thermoplastic elastomers, as well as in other applications.

PO3G derivatives including polyether ester elastomers comprising polytrimethylene ether ester soft segment and tetramethylene or trimethylene ester hard segments are described, for example, in U.S. Pat. Nos. 6,562,457; 6,599,625; 5,128,185; 4,937,314; and 4,906,729; the teachings of which are incorporated herein by reference. In addition, polytrimethylene ether ester amides are described in U.S. Pat. No. 6,590,065, which is incorporated herein by reference. Polyurethanes and polyurethane ureas derived from PO3G are described in U.S. patent application Publication No. 2004/0030060, which is incorporated herein by reference. Heretofore, PO3G derivatives have been primarily directed toward fiber applications due to superior tenacity and elongation properties, among others.

U.S. Pat. No. 4,337,947 discloses a golf ball comprising a thread-wound central core with an outer cover wherein the outer cover comprises (a) an ionomer and (b) polyester elastomer selected from polyetherester, polylactone-ester, or co-polyester.

U.S. Pat. No. 4,398,000 discloses a golf ball comprising a central core and an outer cover wherein the outer cover comprises a polyetherester block copolymer comprising (a) butylene terephthalate units, (b) an ester other than butylene terephthalate, and (c) a polyetherester unit derived from a dicarboxylic acid component comprising terephthalate groups and a poly(alkylene oxide). Suitable poly(alkylene oxide)s include polytetramethylene ether glycol (PTMEG), polytrimethylene ether glycol, and many combinations. Only examples of PTMEG are provided.

U.S. Pat. No. 5,688,191 discloses a golf ball with at least three layers: cover (ionomer), mantle, core wherein the mantle (which can be one or more layers) is a thermoplastic elastomer, such as polyetheresters (Hytrel®) and polyetheramides (Pebax®). The cover of the golf ball may comprise polyethylene terephthalate or polybutylene terephthalate.

There is a continuing need to improve the performance of golf balls with high performance polymeric materials, and in particular, for a softer, tougher and more resilient grade of golf ball than has been previously achieved. The present invention meets this need.

### SUMMARY OF THE INVENTION

The present invention is directed to golf balls, and in particular, to golf balls comprising a core layer and a cover layer, wherein at least one of these layers comprises a polytrimethylene ether glycol (“PO3G”) composition. The present invention is also directed to one-piece golf balls comprising a polytrimethylene ether glycol composition. By “polytrimethylene ether glycol composition”, it is meant the composition comprises trimethylene ether repeat units. Such compositions are polytrimethylene ether glycol derivatives, which include polyether ester elastomers comprising a polytrimethylene ether soft segment; polyether-ester-amide elastomers comprising a polytrimethylene ether soft segment; and polyurethanes and polyurethane-ureas prepared by reaction of (a) polytrimethylene ether glycol, (b) diisocyanate, and (c) diol or diamine chain extender. The PO3G composition may be present either alone or in blends with other polymers.

Additional layers, such as a mantle or other intermediate layer between the core and the cover layer, may be present in the golf ball. If so, the PO3G composition may alternatively be present in the additional layer. Such embodiments are also encompassed within the scope of the present invention.

The PO3G compositions suitable for use in the present invention surprisingly provide advantageous properties to the golf ball of the present invention including: (a) soft touch; (b) enhanced play control, and (c) good durability. Other advantages are described below.

### DETAILED DESCRIPTION OF THE INVENTION

The invention is directed to a golf ball having the advantageous properties described above comprising a core layer and a cover layer, wherein at least one of the layers of the ball is comprised of a polytrimethylene ether-based polymeric composition. Optionally, one or more intermediate layers may be present in the golf ball in addition to the core and the cover. The polytrimethylene ether-based polymeric composition, found to be especially suited for use in the present invention, can be defined as a composition comprising trimethylene ether repeat units. Such compositions include polytrimethylene ether glycol derivatives. Polytrimethylene ether glycol derivatives include polyether ester elastomers comprising a polytrimethylene ether soft segment; polyether-ester-amide elastomers comprising a polytrimethylene ether soft segment; and polyurethanes and polyurethane-ureas prepared by reaction of (a) polytrimethylene ether glycol, (b) diisocyanate, and (c) diol or diamine chain extender. The PO3G composition may be present either alone or in blends with other PO3G compositions or other polymers.

Polytrimethylene Ether Glycol

The polytrimethylene ether glycols useful in the manufacture of PO3G compositions useful in this invention are prepared by the acid-catalyzed polycondensation of 1,3-propanediol, preferably as described in U.S. Published patent application Nos. 2002/7043 A1 and 2002/10374 A1, both of which are incorporated herein by reference. These polytrimethylene ether glycols have a number of features that distinguish them from polytrimethylene ether glycols prepared from oxetane. Most notably, they contain unsaturated end groups, predominately allyl end groups, in the range of about 0.003 to about 0.015 milliequivalents/gram (meq/g), preferably at least about 0.005 meq/g, and preferably up to about 0.014 meq/g, more preferably up to about 0.012 meq/g. In one preferred embodiment, they contain greater than 0.005 meq/g, and more preferably at least 0.006 meq/g, of unsaturated end groups.

The polytrimethylene ether glycols have a number average molecular weight (Mn) in the range of about 1,000 to about 4,000, preferably up to about 3,000.

The polydispersity of the polytrimethylene ether glycol is preferably within the range of about 1.5 to about 2.1. Using blends of polytrimethylene ether glycols, the polydispersity can be adjusted.

The 1,3-propanediol employed for preparing the polytrimethylene ether glycol for use in making the elastomers may be obtained by any of the various chemical routes or by biochemical transformation routes. Preferred routes are described in U.S. Pat. Nos. 5,015,789, 5,276,201, 5,284,979, 5,334,778, 5,364,984, 5,364,987, 5,633,362, 5,686,276, 5,821,092, 5,962,745, 6,140,543, 6,232,511, 6235,948, 6,277,289, 6,297,408, 6,331,264 and 6,342,646, and U.S. patent application Publication Nos. 2004/0225161; 2004/0260125 and 2004/0225162, all of which are incorporated herein by reference in their entireties.

The most preferred source of 1,3-propanediol is a fermentation process using a renewable biological source. As an illustrative example of a starting material from a renewable source, biochemical routes to 1,3-propanediol have been described that utilize feedstocks produced from biological and renewable resources such as corn feed stock. For example, bacterial strains able to convert glycerol into 1,3-propanediol are found in e.g., in the species Klebsiella, Citrobacter, Clostridium, and Lactobacillus. The technique is disclosed in several patents, including, U.S. Pat. Nos. 5,633,362, 5,686,276, and 5,821,092. In U.S. Pat. No. 5,821,092, Nagarajan et al. disclose, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the process of the invention provided a rapid, inexpensive and environmentally responsible source of 1,3-propanediol monomer.

Polvtrimethylene Ether Glycol Compositions

Described hereinbelow are particular polytrimethylene ether glycol (PO3G) compositions useful as one or more layers in the golf ball of this invention. These compositions are also referred to herein as polytrimethylene ether glycol derivatives. It should be recognized that these compositions may be present alone, in blends with other PO3G compositions, or in blends with other polymers.

Polytrimethylene ether ester elastomers

Polytrimethylene ether ester elastomers useful in one or more of the layers of the golf ball of this invention comprise trimethylene ether repeat units. Particularly useful polytrimethylene ether ester elastomers comprise about 90- about 60 weight % polytrimethylene ether ester soft segment and about 10- about 40 weight % trimethylene ester or tetramethylene ester hard segment.

Herein, “polytrimethylene ether ester soft segment” and “soft segment” are used to refer to the reaction product of polymeric ether glycol and dicarboxylic acid equivalent which forms an ester connection, wherein at least 40 weight % of the polymeric ether glycol used to form the soft segment is polytrimethylene ether glycol (PO3G).

When PO3G is used to form the soft segment, it can be represented as comprising units represented by the following structure: 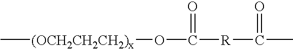
wherein x is preferably about 17 to about 86 and R represents a divalent radical remaining after removal of carboxyl functionalities from a dicarboxylic acid equivalent.

By “hard segment”, reference is to the reaction product of diol(s) and dicarboxylic acid equivalent which forms an ester connection, wherein at least 50 mole %, of the diol used to form the hard segment is 1,3-propanediol or 1,4-butanediol.

The hard segment can be represented as comprising units having the following structure: 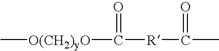
where O(CH₂)_{y}O represents the diol such that in at least 50 mole % of the hard segment, y is 3 or 4. R′ represents a divalent radical remaining after removal of carboxyl functionalities from a dicarboxylic acid equivalent. In most cases, the dicarboxylic acid equivalents used to prepare the soft segment and the hard segment of the polyether ester of this invention will be the same.

The hard segment can also be prepared with up to 50 mole % (preferably up to 25 mole %, more preferably up to 15 mole %), of mixtures of diols. The diol mixture can be a combination of 1,3-propanediol with 1,4-butanediol or one of these with other diols. Preferably, the diols have a molecular weight lower than 400 g/mol. The other diols are preferably aliphatic diols and can be acyclic or cyclic. Preferred are diols with from 2 to 15 carbon atoms such as ethylene, isobutylene, pentamethylene, 2,2-dimethyltrimethylene, 2-methyltrimethylene, hexamethylene and decamethylene glycols, dihydroxy cyclohexane, cyclohexane dimethanol, hydroquinone bis(2-hydroxyethyl)ether. Especially preferred are aliphatic diols containing 2-8 carbon atoms. Most preferred are diol mixtures selected from the group consisting of ethylene glycol, 1,3-propanediol and 1,4-butanediol.

By “dicarboxylic acid equivalent” is meant dicarboxylic acids and their equivalents from the standpoint of making the compositions of this invention, as well as mixtures thereof. The equivalents are compounds that perform substantially like dicarboxylic acids in reaction with glycols and diols.

The dicarboxylic acid equivalents can be aromatic, aliphatic or cycloaliphatic. In this regard, “aromatic dicarboxylic acid equivalents” are dicarboxylic acid equivalents in which each carboxyl group is attached to a carbon atom in a benzene ring system such as those described below. “Aliphatic dicarboxylic acid equivalents” are dicarboxylic acid equivalents in which each carboxyl group is attached to a fully saturated carbon atom or to a carbon atom, which is part of an olefinic double bond. If the carbon atom is in a ring, the equivalent is “cycloaliphatic.”

The dicarboxylic acid equivalent can contain any substituent groups or combinations thereof, so long as the substituent groups do not interfere with the polymerization reaction or adversely affect the properties of the polyether ester product. Dicarboxylic acid equivalents include dicarboxylic acids, diesters of dicarboxylic acids, and diester-forming derivatives such as acid halides (e.g., acid chlorides) and anhydrides.

Especially preferred are the dicarboxylic acid equivalents selected from the group consisting of dicarboxylic acids and diesters of dicarboxylic acids. More preferred are dimethyl esters of dicarboxylic acids.

Preferred are the aromatic dicarboxylic acids or diesters by themselves, or with small amounts of aliphatic or cycloaliphatic dicarboxylic acids or diesters. Most preferred are the dimethyl esters of aromatic dicarboxylic acids.

Representative aromatic dicarboxylic acids are terephthalic, bibenzoic, isophthalic and naphthalic acid; dimethyl terephthalate, bibenzoate, isophthalate, naphthalate and phthalate; and mixtures thereof. Representative aliphatic and cycloaliphatic dicarboxylic acids are sebacic acid, 1,3- or 1,4-cyclohexane dicarboxylic acid, adipic acid, dodecanedioic acid, glutaric acid, succinic acid, oxalic acid, azelaic acid, suberic acid, cyclopentanenedicarboxylic acid, decahydro-1,5- (or 2,6-)naphthalene dicarboxylic acid, and 1,1-cyclobutane dicarboxylate.

The dicarboxylic acid equivalents in the form of diesters, acid halides and anhydrides of the aforementioned aromatic and aliphatic dicarboxylic acids are also useful to provide the polyether ester of the present invention. Representative aromatic diesters include dimethyl terephthalate, dimethyl bibenzoate, dimethyl isophthalate, dimethyl phthalate and dimethyl naphthalate. Particularly preferred dicarboxylic acid equivalents are the equivalents of phenylene dicarboxylic acids especially those selected from the group consisting of terephthalic and isophthalic acid and their diesters, especially the dimethyl esters, dimethyl terephthalate and dimethyl isophthalate. In addition, two or more dicarboxylic acids equivalents can be used. For instance, terephthalic acid or dimethyl terephthalate can be used with small amounts of the other dicarboxylic acid equivalents. In one example, a mixture of diesters of terephthalic acid and isophthalic acid was used.

Polytrimethylene ether-ester-amides

Polytrimethylene ether-ester-amides useful in one or more of the layers of the golf ball of this invention comprise a polytrimethylene ether soft segment and are referred to herein as polytrimethylene ether ester amides. These comprise polyamide hard segments or blocks joined by ester linkages to polyether soft segments or blocks. Thus, they are sometimes referred to as block polymers. They are prepared by reacting carboxyl terminated polyamide (or acid equivalents thereof) and polytrimethylene ether glycol.

Herein, when referring to the polytrimethylene ether ester amide, carboxyl terminated polyamide or acid equivalents thereof, polytrimethylene ether glycol, etc., it should be understood that reference is to one or more of these items. Thus, for instance, when referring to at least 40 weight % of the polymeric ether glycol used to form the soft segment being polytrimethylene ether glycol, it should be understood that one or more polytrimethylene ether glycols can be used.

The general structure of polytrimethylene ether ester amides can be thought of with reference to formula (I): 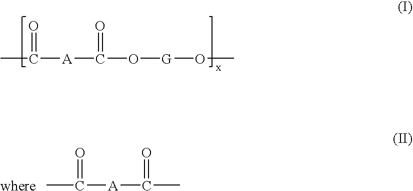
represents a polyamide segment containing terminal carboxyl groups or acid equivalents thereof, and
-O-G-O- (III)
is a polyether segment, and x is 1 up to an average of about 60, and wherein at least 40 weight % of the polyether segments comprise polytrimethylene ether units. (A and G are used to depict portions of the segments which are ascertained from the description of the polytrimethylene ether ester amide and starting materials.)

The polyamide segment preferably has an average molar mass of at least about 300, more preferably at least about 400. Its average molar mass is preferably up to about 5,000, more preferably up to about 4,000 and most preferably up to about 3,000.

The polytrimethylene ether segment preferably has an average molar mass of at least about 800, more preferably at least about 1,000 and more preferably at least about 1,500. Its average molar mass is preferably up to about 5,000, more preferably up to about 4,000 and most preferably up to about 3,500.

The polytrimethylene ether ester amide contains at least 1 polyether ester amide repeat unit. It preferably comprises up to an average of up to about 60 polyalkylene ether ester amide repeat units. Preferably, it averages at least about 5, more preferably at least about 6, polyalkylene ether ester amide repeat units. Preferably, it averages up to about 30, more preferably up to about 25, polyalkylene ether ester amide repeat units.

The weight percent of polyamide segment, also sometimes referred to as hard segment, is preferably at least about 10 weight % and most preferably at least about 15 weight % and is preferably up to about 60 weight %, more preferably up to about 40 weight %, and most preferably up to about 30 weight %. The weight percent of polytrimethylene ether segment, also sometimes referred to as soft segment, is preferably up to about 90 weight %, more preferably up to about 85 weight %, and is preferably at least about 40 weight %, more preferably at least about 60 weight %, and most preferably at least about 70 weight %.

Carboxyl terminated polyamides or acid equivalents thereof, such as diacid anhydrides, diacid chlorides or diesters, useful in preparing the polytrimethylene ether ester amides of this invention are well known. They are described in many patents and publications related to the manufacture of other polyalkylene ester amides, such as U.S. Pat. Nos. 4,230,838, 4,252,920, 4,331,786, 4,349,661 and 6,300,463, all of which are incorporated herein by reference.

Preferred polyamides are those having dicarboxylic chain ends and most preferred are linear aliphatic polyamides which are obtained by methods commonly used for preparing such polyamides, such as processes comprising the polycondensation of a lactam, an amino acid or a diamine with a diacid, such as described in U.S. Pat. No. 4,331,786, which is incorporated herein by reference.

Preferred polyether ester amides are those in which the carboxyl terminated polyamide was derived from the polycondensation of lactams or amino acids with a dicarboxylic acid. The dicarboxylic acid functions as a chain limiter and the exact ratio of lactam or amino-acid to dicarboxylic acid is chosen to achieve the final desired molar mass of the polyamide hard segment. Preferred lactams contain from 4 to 14 carbon atoms, such as lauryl lactam, caprolactam and undecanolactam. Most preferred is lauryl lactam. Preferred amino acids contain from 4 to 14 carbon atoms and include 11-amino-undecanoic acid and 12-aminododecanoic acid. The dicarboxylic acid can be either linear aliphatic, cycloaliphatic, or aromatic. The preferred dicarboxylic acids contain from 4 to 14 carbon atoms. Examples include succinic acid, adipic acid, suberic acid, azelaic acid, sebacic acid, undecanedioic acid, dodecanedioic acid, terephthalic acid, and isophthalic acid. Most preferred are the linear aliphatic dicarboxylic acids, especially adipic acid and dodecanedioic acid.

The polyamide can also be a product of the condensation of a dicarboxylic acid and diamine. In this case, an excess of the diacid is used to assure the presence of carboxyl ends. The exact ratio of diacid to diamine is chosen to achieve the final desired molar mass of the polyamide hard segment. Linear aliphatic or cycloaliphatic diacids can be used. The preferred dicarboxylic acids contain from 4 to 14 carbon atoms and most preferred are linear aliphatic dicarboxylic acids that contain from 4 to 14 carbon atoms. Examples include succinic acid, adipic acid, suberic acid, azelaic acid, sebacic acid, undecanedioic acid and dodecanedioic acid. Most preferred is dodecanedioic acid. Linear aliphatic diamines containing from 4 to 14 carbon atoms are preferred. Hexamethylenediamine is most preferred. Examples of polyamides derived from the aforementioned diacids and diamines include nylon 6-6, 6-9, 6-10, 6-12 and 9-6, which are products of the condensation of hexamethylene diamine with adipic acid, azelaic acid, sebacic acid, 1,12-dodecanedioic acid, and of nonamethylene diamine with adipic acid, respectively.

Polyurethanes and Polyurethane-Ureas

Polyurethanes and polyurethane-ureas useful in one or more of the layers of the golf ball of this invention are prepared by reaction of (a) polytrimethylene ether glycol, (b) diisocyanate, and (c) diol or diamine chain extender.

Polytrimethylene ether glycol is described above.

Any diisocyanate useful in preparing polyurethanes and polyurethane-ureas from polyether glycols, diisocyanates and diols or amines can be used in this invention. They include 2,4-toluene diisocyanate, 2,6-toluene diisocyanate (“TDI”), 4,4′-diphenylmethane diisocyanate or (“MDI”), 4,4′-dicyclohexylmethane diisocyanate (“H₁₂MDI”), 3,3′-dimethyl-4,4′-biphenyl diisocyanate (“TODI”), 1,4-benzene diisocyanate, trans-cyclohexane-1,4-diisocyanate, 1,5-naphthalene diisocyanate (“NDI”), 1,6-hexamethylene diisocyanate (“HDI”), 4,6-xylene diisocyanate, isophorone diisocyanate (“IPDI”), and combinations thereof. MDI, HDI, and TDI are preferred because of their ready commercial availability.

Polyurethanes are formed when diol chain extenders are used, as polytrimethylene ether glycols and alcohols bond to isocyanates to form urethane linkages. Polyurethane-ureas are formed when diamine chain extenders are used, as polytrimethylene ether glycols and isocyanates bond to form urethane linkages and amines bond to isocyanates to form urea linkages.

Any diol or diamine chain extender useful in preparing polyurethanes and polyurethane-ureas from polyether glycols, diisocyanates and diol or amine chain extenders can be used in this invention.

Diol chain extenders useful in making the polyurethanes used in the invention include ethylene glycol, 1,2-propylene glycol, 1,3-propanediol, 1,4-butanediol, 1,6-hexanediol, diethylene glycol, 2-methyl-1,3-propanediol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, bis(hydroxyethylene)terephthalate, hydroquinone bis(2-hydroxyethyl)ether, and combinations thereof. Preferred are ethylene glycol, 1,2-propylene glycol, 1,3-propanediol, 1,4-butanediol, 1,6-hexanediol, and 2-methyl-1,3-propanediol.

Diamine chain extenders useful in making the polyurethanes used in the invention include 1,2-ethylenediamine, 1,6-hexanediamine, 1,2-propanediamine, 4,4′-methylene-bis(3-chloroaniline) (also known as 3,3′-dichloro-4,4′-diaminodiphenylmethane) (“MOCA” or “Mboca”), dimethylthiotoluenediamine (“DMTDA”), 4,4′-diaminodiphenylmethane (“DDM”), 1,3-diaminobenzene, 1,4-diaminobenzene, 3,3′-dimethoxy-4,4′-diamino biphenyl, 3,3′-dimethyl4,4′-diamino biphenyl, 4,4′-diamino biphenyl, 3,3′-dichloro-4,4′-diamino biphenyl, and combinations thereof.

Processes to prepare such polyurethanes and polyurethane-ureas are described in U.S. patent application Publication No. 2004/0030060.

The present invention also contemplates the use of a variety of materials blended with at least one PO3G composition to form one or more layers of a golf ball.

Thermoplastic resins

Ionomers or non-ionic thermoplastic resins can be blended with the PO3G containing compositions for performance enhancement. Examples of ionomers include ethylene ionomers containing acrylic or methacrylic acid which are at least partially neutralized by alkaline metals, alkaline earth metals, or transition metals, and optionally containing softening comonomers, like butyl acrylate, vinyl acetate, methyl acrylate, etc. Examples of nonionic thermoplastic resins include thermoplastic elastomers, such as polyesters, polyamides, polyether ester, polyether-amide, polyether urea, styrenic thermoplastic elastomers, Pebax®, etc., elastomers, like polybutadine, EPDM, ethylene copolymers, etc. The fatty acid salt modified ionomers, like those described in U.S. Pat. Nos. 6,100,321 and 6,653,382 are also thermoplastic resins that could be used in the blends of this invention.

Fillers

For example, an optional filler component may be chosen to impart additional density to the compositions. Preferred densities for the filled compositions include densities in the range starting with the density of unfilled polymer to 1.8 gm/cc. Generally, the filler will be inorganic, having a density greater than about 4 gm/cc, preferably greater than 5 gm/cc, and will be present in amounts between 0 and about 60 weight % based on the total weight of the composition. Examples of useful fillers include zinc oxide, barium sulfate, lead silicate, tungsten carbide, and tin oxide, as well as the other well known corresponding salts and oxides thereof.

Other Components

Other optional additives include titanium dioxide, which is used as a whitening agent or filler; other pigments, optical brighteners; surfactants; processing aids; etc.

Golf Balls Comprising PO3G Composition

The PO3G compositions described herein are useful substitutions for one or more materials taught in the art at the levels taught in the art for use in covers, mantles, intermediate layers, cores, and centers of golf balls, or one-piece golf balls.

Golf balls incorporating a PO3G composition exhibit improved properties, such as soft feel, better play control, good durability, among others, compared to conventional golf balls.

A golf ball in accordance with this invention comprises one piece or two or more layers wherein the layers may include a cover, mantle, intermediate layer, core, and/or center, made from a PO3G-derived polymer composition described herein replacing any traditional material used to prepare golf balls, such as ionomer resin, balata rubber, thermoset polybutadiene rubber, thermoset or thermoplastic polyurethanes and the like. The golf balls will have a traditional dimple pattern and may be further coated with a polyurethane coating or painted for appearance purposes. Such a coating and/or painting will not affect the performance characteristics of the ball. However, coating and/or painting may affect the scuff resistance of the ball. In particular, such coating and/or painting may improve scuff resistance over that of an unfinished ball. For the purposes of this invention, any coating and/or painting are not considered to be part of a golf ball cover.

The specific combinations of materials used in the practice of the subject invention will in large part be dependent upon the type of golf ball desired (e.g., one-piece, two-piece, three-piece, or multi-piece), and in the type of performance desired for the resulting golf ball. In addition, a golf ball typically must meet the mass limit (45.93 grams) set by the United States Golfing Association (U.S.G.A.) or some other limit set by a golfer's governing authority. Preferably, the ball has a density of about 1.128 gm/cc.

The core, mantle and/or intermediate layers may comprise a filler as described above. The amount of filler employed in these layers may vary from 0 to about 60 wt. % depending on the size (thickness) of the layers and the desired location of the weight in the ball, provided that the final ball meets the required weight limits. The filler can be used in the core and not in the mantle, in the mantle and not in the core, or in both. While not intending to be limiting as to possible combinations, this embodiment includes:
1. a core or center comprising a PO3G composition and a mantle made of any composition known in the art;
2. a core or center comprising a PO3G composition and a mantle made of a PO3G composition with or without filler, adjusted to provide a golf ball of the desired weight; or
3. a core made of any composition (including thermoset compositions such as polybutadiene rubber) with a mantle comprising a PO3G composition with or without filler provided that the weight of the finished golf ball meets the required limit.

The golf balls of the present invention can be produced by molding processes that include but are not limited to those that are currently well known in the golf ball art. For example, the golf balls can be produced by injection molding or compression molding a cover or mantle comprising a composition described herein around a wound or solid molded core to produce a golf ball having a diameter of at least 1.680 inches and typically but not necessarily having a mass of about 45.93 g.

For the purposes of this invention, the term “wound core” refers to a core consisting essentially of a center with an elastomeric winding around the center and the term “solid core” indicates a molded core without the elastomeric winding.

One-Piece Golf Ball

As used herein, the term “one-piece ball” refers to a golf ball molded from a thermoplastic composition, i.e., not having elastomeric windings, cores or mantles and in which the whole ball is a homogeneous solid spheroid. The one-piece molded ball will have a traditional dimple pattern and may be coated with a polyurethane coating or painted for appearance purposes, but such a coating and/or painting will not affect the performance characteristics of the ball. These one-piece balls are manufactured by direct injection molding techniques or by compression molding techniques. The present invention provides a one-piece golf ball comprising a PO3G composition described herein further comprising other materials typically used in one-piece balls.

Of note are one-piece balls wherein sufficient filler is added to the PO3G composition (i.e. a composition as described herein) used to prepare the golf ball to adjust the mass of the golf ball to a level meeting the limits set by the golfer's governing authority. Preferably, enough filler is used so that the ball has a density of 1.128 g/cc.

Multi-Piece Balls

As used herein, the term “multi-piece ball” refers to two-piece, three-piece and multilayer golf balls as described further below.

### Two-Piece Golf Ball Preferred Embodiments

As used herein, the term “two-piece ball” refers to a golf ball comprising a solid core and a cover. These two-piece balls are manufactured by first molding the core from a thermoset or thermoplastic composition, positioning these preformed cores in injection molding cavities using retractable pins, then injection molding the cover material around the cores. Alternatively, covers can be produced by compression molding cover material over the cores.

The solid core layer of a golf ball of this invention may comprise a variety of materials, including those conventionally employed as golf ball cores. The conventional materials for such cores include core compositions having a base rubber, a crosslinking agent, a filler and a co-crosslinking agent. The base rubber typically includes natural or synthetic rubbers. A preferred base rubber is 1,4-polybutadiene having a cis-structure of at least 40%. Natural rubber, polyisoprene rubber and/or styrene-butadiene rubber may be optionally added to the 1,4-polybutadiene. The crosslinking agent typically includes a metal salt of an unsaturated fatty acid such as a zinc salt or a magnesium salt of an unsaturated fatty acid having from 3 to 8 carbon atoms such as acrylic or methacrylic acid. When a core is prepared from such conventional materials, a cover comprising at least one PO3G composition is molded over the core to prepare a golf ball of this invention.

Alternatively, the PO3G composition described herein can be used as the core of such golf balls to prepare a golf ball of this invention. For purposes of this invention, such cores are made by injection or compression molding a sphere of desired size from a PO3G composition or its blends, such as with ionomers or non-ionomeric thermoplastic resins that may be filled with sufficient filler to provide a core density of from about 1.12 gm/cc to about 1.2 gm/cc depending on the diameter of the core and the thickness and composition of the cover to produce a golf ball meeting the desired weight and size.

### Three-Piece Golf Ball Preferred Embodiments

Three-piece balls are manufactured by well-known techniques as described in, e.g., U.S. Pat. No. 4,846,910. As used herein, the term “three-piece ball” refers to a golf ball comprising a wound core, consisting of a center with a traditional elastomeric winding around the center, and a cover. A wound core is generally produced by winding a very large elastic thread around a solid center or a liquid-filled balloon center. The solid center is typically a homogenous mass of a resilient material such as polybutadiene or a natural rubber. The liquid-filled center is typically a thin-walled sphere into which a liquid such as corn syrup is injected by means of a hypodermic needle. The sphere is then sealed and frozen to make the center a solid mass. The windings for either type of center are provided by an elastic thread that is stretched and wound about the center to a desired thickness. For purposes of this invention, such elastic thread may comprise a PO3G composition. Also for purposes of this invention, the solid center of these three-piece balls may be made by injection or compression molding a sphere of desired size from a PO3G composition or its blends with other polymers, such as ionomers or non-ionomeric thermoplastic resins, that is filled with sufficient filler to provide a center density to meet the golf ball design requirements of the three-piece balls.

Multilayer Golf Ball

As used herein, the term “multilayer ball” refers to a golf ball comprising a core, a cover, and one or more mantles or intermediate layers between the core and the cover. These multilayer balls are manufactured by first molding or making the core, typically compression or injection molding the mantle(s) over the core and then compression or injection molding a cover over the mantle. The PO3G compositions described herein can be used as at least one of the core, mantle, intermediate layers, and/or the cover of such golf balls to prepare a golf ball of this invention.

Cores of multilayer balls may be solid or wound, as described above. As indicated, additional mantle layer(s) and cover layer(s) are applied over the core to produce a multilayer ball, using procedures similar to those already described.

Covers, mantles, intermediate layers, cores, centers for golf balls comprising the PO3G composition described herein, or blends thereof with ionomeric and/or non-ionomeric thermoplastic resins, are included in this invention. In particular, the core and/or cover layers of the golf ball of this invention may comprise an ionomeric polymer or copolymer. Such copolymers include those which are available under the trademark SURLYN®) from E. I. du Pont de Nemours and Company of Wilmington, Del. (copolymers of ethylene and methacrylic acid partially neutralized with zinc, sodium or lithium); and those which are available under the trademarks IOTEK® or ESCORE® from Exxon Chemical Company, Houston, Tex., (copolymers of ethylene and acrylic acid partially neutralized with zinc or sodium).

The covers, mantles, or intermediate layers can be made by injection or compression molding the PO3G composition described above (with or without fillers, other components, and other thermoplastics including ionomers and/or non-ionomers) over a thermoplastic or thermoset core of a two-piece, three-piece, or multi-layered golf ball, over a core or windings around a thermoplastic or thermoset center.

In two-piece, three-piece or multilayer balls, sufficient filler may be added to one or more components (i.e. core, mantle, intermediate layer, and/or covers) of the golf ball to adjust the mass of the golf ball to a level meeting the limits set by the golfer's governing authority. Depending on the composition(s) of the other pieces of the ball, covers or intermediate layers of this invention can be prepared from the PO3G compositions described herein modified with filler(s) as described above to meet the mass limit.

The cover layer of the golf ball of the present invention may comprise at least one PO3G composition. Additional materials may be present in the cover layer. Among the preferred conventional cover materials are ionomeric polymers or copolymers, such as those commercially available from E. I. du Pont de Nemours and Company under the tradename SURLYN®. Likewise, other conventional materials such as balata, elastomer and polyethylene may also be used in the cover layers of the present invention. Additionally, foamed polymeric materials are suitable for use in the cover layers of the present invention. In particular, metallocene-based foam resins are useful in the cover layers of the present invention.

In a preferred embodiment of the present invention, the cover layer comprises an inner layer and an outer layer. The inner layer of the cover is either a thermoplastic material such as a thermoplastic elastomer or a thermoplastic rubber. PO3G compositions, in particular, polyether ester elastomers and polyether-ester-amides, are suitable for the inner layer.

The outer layer of the cover is either a thermoplastic plastic material such as an elastomer or a thermoplastic rubber, or a thermosetting material. Suitable materials for the outer layer include urethanes, ionomers with a low modulus and other durable materials such as styrenic thermoplastic elastomers, EPDM and butyl rubber. PO3G compositions, in particular, polyurethanes and polyurethane-ureas prepared by reaction of (a) polytrimethylene ether glycol, (b) diisocyanate, and (c) diol or diamine chain extender are suitable for use in the outer layer of the golf ball of this invention.

As indicated, the golf balls of this invention can be produced by forming covers or mantles comprising the PO3G composition around cores by molding processes. For example, in compression molding, the cover composition is formed via injection at e.g. about 190° C. to about 235° C. into smooth hemispherical shells which are positioned around the core in a dimpled golf ball mold and subjected to compression molding at e.g. 90 to 235° C. for one to ten minutes, followed by cooling at 10 to 22° C. for one to ten minutes, to fuse the shells together to form a unitary ball. In one type of injection molding, the cover or mantle composition is injected directly around the core placed in the center of a golf ball mold for a period of time at a mold temperature from about 10° C. to 65° C.

One-piece balls, cores and centers may be prepared by similar injection molding methods.

After molding, the golf balls produced may undergo various further processing steps such as buffing, painting and marking.

The golf ball of the present invention advantageously provides improved performance with a softer touch, more resilience, enhanced play control and good durability.

### EXAMPLES

The following examples are presented for the purpose of illustrating the invention, and are not intended to be limiting. All parts, percentages, etc., are by weight unless otherwise indicated.

### Test Methods

Test Method 1.

Inherent Viscosity (I.V.) of the polymer samples were analyzed on the PolyVisc automated viscometer at a temperature of 30° C. in m-cresol with an 0.5% concentration.

Test Method 2.

The molecular weight of the polymer was analyzed using Size Exclusion Chromatography (SEC) with triple detection after dissolving the polymer in HFIP (Hexafluoroisopropanol) and eluting from a Shodex 806M column.

### Example 1

The polyether ester was prepared by reacting polytrimethylene ether glycol (7.92 lbs corresponding to 72% by weight) and poly(1,4-butylene terephthalate) (Crastin 6130; 3.08 lbs corresponding to 28% by weight) in the presence of a titanium tetrabutoxide catalyst (113.5 g of 5% 1,4-butanediol stock solution, and Ethanox 330 antioxidant (17 g).

All reagents are charged to a 10 pound autoclave reactor and 3 N₂/purge cycles were completed. The reaction mixture was heated to 250° C. under N₂. When 140° C. is reached, the stirrer is turned on and set to 15 RPM. After 250° C. was reached, the reaction was brought under vacuum (0.7-1.0 mm Hg) for 3.5 hours. The melt was extruded through an opening in the bottom of the vessel into trays of ice water and was chopped into flakes when cool. The flakes were dried overnight in a vacuum oven with N₂ purge at 100° C.

The polymer has a number average molecular weight of 32,700 and weight average molecular weight of 50,800 with a polydispersity of 1.55. The intrinsic viscosity of this polymer is found to be 1.309 dL/g

### Example 2

The polymer was prepared using a batch process from dimethyl terephthalate,1,4-butanediol and polytrimethylene ether glycol. An autoclave reactor equipped with an agitator, vacuum jets and a distillation still was charged with 19.4 lbs of dimethyl terephthalate, 19.6 lbs of 1,4-butanediol, and 44.1 lbs of polytrimethylene ether glycol of number average molecular weight 2,000. Tetraisopropyl titanate polymerization catalyst (40.4 g) and ETHANOX antioxidant (37.7 g) were also charged to this reactor. The temperature of the reactor was gradually raised to 210° C., and approximately 2.7 kg of methanol distillate were recovered. The reaction was continued further at 250° C. and under reduced pressure for 2 h 30 min to increase molecular weight. The resulting polymer was extruded from the reactor and converted into pellets. The pellets were dried at 80-90° C. under reduced pressure overnight before use.

### Example 3

The polymer was prepared using a batch process from dimethyl terephthalate, 1,4-butanediol and polytrimethylene ether glycol. An autoclave reactor equipped with an agitator, vacuum jets and a distillation still was charged with 32.4 lbs of dimethyl terephthalate, 37.9 lbs of 1,4-butanediol, and 33.1 lbs of polytrimethylene ether glycol of number average molecular weight 2,000. Tetraisopropyl titanate polymerization catalyst (50.3 g) and ETHANOX antioxidant (93.8 g) were also charged to this reactor. The temperature of the reactor was gradually raised to 210° C., and approximately 4.5 kg of methanol distillate were recovered. The reaction was continued further at 250° C. and under reduced pressure for 3 hours to increase molecular weight. The resulting polymer was extruded from the reactor and converted into pellets. The pellets were dried at 80-90° C. under reduced pressure overnight before use.

### Example 4

The polymers of Examples 1-3 were fabricated into spheres of 1.51-1.53″ diameter by injection molding as described in U.S. Pat. No. 6,653,382. The spheres were then evaluated for Coefficient of Restitution (COR) and PGA Compression (using Atti machine) as described in U.S. Pat. No. 6,653,382. The data is summarized in Table 1.

### Example 5

A salt and pepper blend of 30% of the pellets of the polymer of Example 1 and 70% of a polymer described in U.S. Pat. No. 6,653,382 having a COR of 0.836 and Compression of 89 was prepared. The mixture of pellets was then fed via a mixing screw to an injection mold to prepare spheres of 1.51″ diameter. The spheres were then evaluated for Coefficient of Restitution (COR) and PGA Compression (using Atti machine) as described in U.S. Pat. No. 6,653,382. The data is summarized in Table 1.

### Example 6

A salt and pepper blend of 10% of the pellets of the polymer of Example 1 and 90% of a polymer described in U.S. Pat. No. 6,653,382 having a COR of 0.836 and Compression of 89 was prepared. The mixture of pellets was then fed via a mixing screw to an injection mold to prepare spheres of 1.52″ diameter. The spheres were then evaluated for Coefficient of Restitution (COR) and PGA Compression (using Atti machine) as described in U.S. Pat. No. 6,653,382. Shore D Hardness was measured on the neat spheres. The data is summarized in Table 1.

TABLE 1
Golf Ball Sphere Properties of PO3G-Based Material & Blend

| Resin | COR | Compression | Shore D Hardness |
|---|---|---|---|
| Ex. 1 | 0.662 | 19 | 23.9 |
| Ex. 2 | 0.690 | 2 | 30.4 |
| Ex. 3 | 0.671 | 102 | 47.1 |
| Ex. 5 | 0.799 | 66 | 36.1 |
| Ex. 6 | 0.826 | 83 | 42.1 |

Examples 1-3 show that resilient golf ball materials with a wide range of compression values may be made from a polymer containing 1,3-propanediol, a bio-renewable monomer. Examples 5 and 6 further demonstrate that resilient golf ball materials with a wide range of compression values may be made from blends of elastomers with a polymer containing 1,3-propanediol, a bio-renewable monomer.

1. A golf ball comprising a core and a cover layer wherein at least one of said layers comprises a polytrimethylene ether glycol composition.

2. The golf ball of claim 1 wherein the polytrimethylene ether glycol composition is a polyether ester elastomer comprising a polytrimethylene ether soft segment and a hard segment which is the reaction product of diol(s) and dicarboxylic acid equivalent which forms an ester connection.

3. The golf ball of claim 1 wherein the polytrimethylene ether glycol composition is a polyether-ester-amide elastomer comprising a polytrimethylene ether soft segment and a polyamide hard segment.

4. The golf ball of claim 1 wherein the polytrimethylene ether glycol composition is a polyurethane or a polyurethane urea prepared by the reaction of (a) polytrimethylene ether glycol, (b) diisocyanate, and (c) diol or diamine chain extender.

5. The golf ball of claims 2, 3, or 4 wherein the polytrimethylene ether glycol composition is present in a blend with other polymers.

6. The golf ball of claim 5 wherein the polytrimethylene ether glycol composition is present in a blend with an ionomer or non-ionic thermoplastic resin.

7. The golf ball of claim 1 wherein the golf ball comprises a solid core and a cover and wherein the polytrimethylene ether glycol composition is present in the core, in the cover, or both.

8. The golf ball of claim 1 comprising a wound core, said wound core comprising a center with an elastomeric winding around the center and a cover, wherein the polytrimethylene ether glycol composition is present in the core, the center, the cover, or in any of the above.

9. A golf ball comprising a core, a cover, and one or more mantles or intermediate layers between the core and the cover, wherein the polytrimethylene ether glycol composition is present in the core, the cover, in one or more mantles or intermediate layers, or in any of the above.

10. The golf ball of claim 1 wherein the core, the cover layer or both, further comprise an ionomeric polymer or copolymer.

11. The golf ball of claims 7, 8 or 9 further comprising a filler component.

12. The golf ball of claim 2 wherein the soft segment is represented by the structure 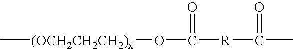
wherein x is about 17 to about 86 and R is a divalent radical remaining after removal of carboxyl functionalities from a dicarboxylic acid equivalent, and the hard segment is represented as 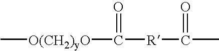
where —O(CH₂)_{y}O— represents the diol such that in at least 50 mole % of the hard segment, y is 3 or 4 and R′ represents a divalent radical remaining after removal of carboxyl functionalities from a dicarboxylic acid equivalent.

13. The golf ball of claim 12 wherein the polytrimethylene ether ester comprises about 90 to about 60 weight % polytrimethylene ether soft segment, and about 10 to about 40 weight % trimethylene ester or tetramethylene ester hard segment or mixtures thereof.

14. The golf ball of claim 13 wherein the dicarboxylic acid equivalents in the soft segment and the hard segment are selected from the group consisting of dicarboxylic acids and diesters of dicarboxylic acids.

15. The golf ball of claim 14 wherein the dicarboxylic acid equivalents are aromatic dicarboxylic acids or diesters.

16. The golf ball of claim 15 wherein the dicarboxylic acid equivalents are dimethyl esters of aromatic dicarboxylic acids.

17. The golf ball of claim 3 wherein the polyamide hard segment has an average molar mass of at least 300.

18. The golf ball of claim 17 wherein the polyamide hard segment has an average molar mass up to about 5,000.

19. The golf ball of claim 17 wherein the polytrimethylene ether soft segment has an average molar mass of at least 800.

20. The golf ball of claim 19 wherein the polytrimethylene ether soft segment has an average molar mass of up to about 5,000.

21. The golf ball of claim 3 wherein the polyether-ester-amide elastomer comprises about 90 to about 40 weight % polytrimethylene ether soft segment and about 10 to about 60 weight % polyamide hard segment.

22. The golf ball of claim 21 wherein the polyamide is a linear aliphatic polyamide.

23. The golf ball of claim 4 wherein the diisocyanate is 2,6-toluene diisocyanate, 4,4′-diphenylmethane diisocyanate, or 1,6-hexamethylene diisocyanate.

24. The golf ball of claim 4 wherein the polytrimethylene ether glycol composition is a polyurethane.

25. The golf ball of claim 4 wherein the polytrimethylene ether glycol composition is a polyurethane urea.

26. The golf ball of claim 1 wherein the core layer comprises the polytrimethylene ether glycol composition.

27. The golf ball of claim 26 which further comprises a mantle layer comprising a polytrimethylene ether glycol composition.

28. The golf ball of claim 27 wherein the mantle layer further comprises a filler.

29. The golf ball of claim 1 further comprising a mantle wherein the mantle comprises a polytrimethylene ether glycol composition.

30. The golf ball of claim 29 wherein the mantle further comprises a filler.

31. A one-piece golf ball comprising a polytrimethylene ether glycol composition.

32. The golf ball of claim 31 wherein the polytrimethylene ether glycol composition is a polyether ester elastomer comprising a polytrimethylene ether soft segment.

33. The golf ball of claim 31 wherein the polytrimethylene ether glycol composition is a polyether-ester-amide elastomer comprising a polytrimethylene ether soft segment.

34. The golf ball of claim 31 wherein the polytrimethylene ether glycol composition is a polyurethane or a polyurethane urea prepared by the reaction of (a) polytrimethylene ether glycol, (b) diisocyanate, and (c) diol or diamine chain extender.

35. The golf ball of claims 32, 33, or 34 wherein the polytrimethylene ether glycol composition is present in a blend with other polymers.

36. The golf ball of claim 35 wherein the polytrimethylene ether glycol composition is present in a blend with an ionomer or non-ionic thermoplastic resin.

37. The golf ball of claim 31 further comprising sufficient filler to adjust the mass of the golf ball to a density of 1.128 g/cc.

38. The golf ball of claim 1 wherein the polytrimethylene ether glycol is produced from 1,3-propanediol derived from a fermentation process using a renewable biological source.
